(19) United States
(12) Patent Application Publication
(10) Pub. No.: US 2026/0146925 A1
(43) Pub. Date: May 28, 2026

(54) SOLID PHASE EXTRACTION OF ACIDIC BIOMARKERS PRESENT IN OIL SAMPLES, SEDIMENTARY ROCK EXTRACTS, AND PLANT MATERIAL

(71) Applicants: Petróleo Brasileiro S. A. -Petrobras, Rio de Janeiro (BR); Universidade Federal do Piaui- UFPI, Teresina (BR)

(72) Inventors: Rodrigo CABRAL DA SILVA, Rio de Janeiro (BR); EdymilaÌs Da Silva Sousa, Teresina (BR); Gustavo Rodrigues De Sousa Junior, Teresina (BR); Sidney Gonçalo De Lima, Teresina (BR); Alexandre Araujo De Souza, Teresina (BR); Márcio Dos Santos Rocha, Teresina (BR); Carlos Alberto Carbonezi, Rio de Janeiro (BR); Andre Luiz Durante Spigolon, Rio de Janeiro (BR); Alek André Costa De Sousa, Teresina (BR)

(73) Assignees: Petróleo Brasileiro S. A. -Petrobras, Rio de Janeiro (BR); Universidade Federal do Piaui- UFPI, Teresina (BR)

(21) Appl. No.: 19/393,434

(22) Filed: Nov. 18, 2025

(30) Foreign Application Priority Data
Nov. 22, 2024 (BR) 1020240243617

(51) Int. Cl. G01N 1/40; G01N 30/00; G01N 30/72

(52) U.S. Cl. CPC G01N 1/405; G01N 30/7206; G01N 2030/009

(57) ABSTRACT

The present invention relates to a method of solid phase extraction (SPE) of fractions enriched in acidic biomarkers present in oil samples, sedimentary rock extracts and plant material by applying the modified SiO₂/Ca(OH)₂ stationary phase at a proposed concentration between 2 to 10% by weight.

### CROSS-REFERENCE TO RELATED APPLICATIONS

This application claims priority to Brazilian Patent Application No. 10 2024 024361 7, filed Nov. 22, 2024, the entire contents of which is incorporated herein by reference.

### FIELD OF THE DISCLOSURE

The present invention relates to a method of solid phase extraction (SPE) of fractions enriched in acidic biomarkers present in oil samples, sedimentary rock extracts and plant material by applying the modified SiO₂/Ca(OH)₂ stationary phase.

The fields of application of the present invention consist of modeling, simulation and evaluation of oil reservoirs and phytochemical evaluation, in the instance of plant materials.

### BACKGROUND OF THE DISCLOSURE

Carboxylic acids are commonly found in sedimentary rocks, petroleum as well as plant materials and represent the major lipid constituents of living organisms. Accordingly, they provide important complementary information for the study of the organic geochemistry of geological samples. However, analysis of these compounds is challenging due to their low relative abundance and the limitations of currently available analytical methods, resulting in their investigation being considerably less extensive compared to that of neutral biomarkers [1]. Although the carboxylic acid fraction in ancient sediments and oils is not routinely used in petroleum biomarker studies, they have proven quite useful in thermal evolution studies, in studies related to biodegradation and the establishment of diagenetic pathways, as well as in the characterization of recent sediments and crude oils. Therefore, such acidic biomarkers are expected to be employed in the near future in routine analyses as well as in exploration and correlation studies [2]. In addition to its geological relevance, the study of the acidic fraction composition is also of economic interest. Although the relative abundance of acids in crude oils is generally low, their emulsifying and corrosive characteristics make them particularly important as they cause a corrosive effect in distillation towers, directly affecting the costs associated with processing and refining [3]. Similar to neutral biomarkers, acidic biomarkers can be classified into different classes of compounds based on their carbon skeletons, including fatty acids, acyclic isoprenoids, terpanoic (bicyclic, tricyclic and pentacyclic), steranoic, hopanoic and naphthenic acids. Analysis of carboxylic acids requires fractionation, which may involve multiple separation steps of the neutral fraction (saturated and aromatic hydrocarbons) from the acidic fraction. The choice of the separation method to be employed depends on the working conditions and technique optimization [4].

It is worth noting that in the oil industry, the precise and efficient extraction of acidic biomarkers can contribute to the detailed characterization of oil reservoirs. Acidic biomarkers are an important tool in molecular organic geochemistry, which is capable of providing valuable information to corroborate the information achieved through saturated and aromatic biomarkers, including oil-rock correlation, oil-oil correlation, maturity, biodegradation, and the origin of oils or extracts. Therefore, application of SiO₂/Ca(OH)₂ stationary phase in solid phase extraction (SPE), as suggested in the present invention, offers a wide range of application. In addition to enabling the efficient extraction of acidic biomarkers in crude oil samples, sedimentary rock extracts, and plant extracts, this approach offers significant advantages for process scalability and automation. The possibility to automate the production of the stationary phase, which is a simple and inexpensive Lewis base, broadens the potential for industrial-scale implementation, enabling its large-scale use with both efficiency and consistency. This technology has the potential to benefit other sectors, such as agriculture, chemistry, pharmacy and nutrition, when applied to the extraction of bioactive carboxylic acids from plant extracts. Therefore, the present invention represents a promising tool for the accurate and reliable analysis of these compounds in a variety of complex samples.

As seen below, the state of the art does not disclose the solution proposed in the present invention.

### STATE OF THE ART

The acidic nature of compounds in petroleum and rock extracts allows their removal by liquid-liquid extraction (LLE), using alkaline solutions with NaOH and KOH. Studies by Seifert et al. [5, 6, 7 and 8] used isopentane/1% NaOH in 70% ethanol to extract various acids and phenols. Despite being widely used, this method is subject to the formation of emulsions, co-extraction of impurities and high demand for solvents. In the oil industry, the SARA method is routinely used to separate compounds, but it is limited in obtaining acids due to the irreversible adsorption on silanol groups. Alternatives include modification of silica with KOH or aminopropyl and cyanopropyl groups. Borgund et al. [9 and 10] and Green et al. [11 and 12] used HPLC with specific columns to isolate acids, highlighting the efficiency and speed of the method. The literature shows adaptations of KOH-modified silica in Soxhlet and addition funnels to isolate fatty acids from oils. Studies such as those by McCarthy and Duthie [13] and Keeney [14] applied silicic acid with KOH for this purpose. Other works, such as those by Jaffe et al. [15 and 16] and Farrimond et al. [17], adapted the methodology for carboxylic acids in oil and rocks, despite the need for large amounts of sample and solvents. Barakat and Rullkotter [18] used column liquid chromatography (COL) with KOH-impregnated silica to isolate acids from sediments, using 1% formic acid in CH₂Cₗ₂/CH₃OH (99:1 v/v) as eluent. Although efficient, COL is less advantageous for large volumes due to the low concentration of carboxylic acids in crude oil. Solid phase extraction (SPE) has gained prominence recently, offering advantages such as uniformity of the stationary phase, low consumption of solvent and process speed. SPE uses solid particles in cartridges with strong anion exchange (SAX). Studies such as those by Jones et al. [19 and 20], Lamorde et al. [21], Sessions et al. [22] and Zhu et al. [23] demonstrate the use of SPE to isolate carboxylic acids in sediments and oils, using eluents such as hexane and 2% ethyl ether/formic acid. In addition to petroleum and sedimentary rocks, these techniques have been applied to the analysis of plant extracts, showing metabolic processes and environmental interactions of plants.

The review article entitled “An Alternative Method for the Separation and Analysis of Acidic Biomarkers from Crude Oil Samples” [24] shows some works describing the use of stationary phases in the solid phase extraction (SPE) method, however, none of these works addresses a strategy identical to that described in the present invention. Interestingly, given the scope expected of a review article, none of the cited studies report, present, or discuss data on carboxylic acids that are structurally and diagenetically related to hydrocarbons typically used as biomarkers, that is, data on long-chain fatty acids, isoprenoic, drimanoic, cheilanthanoic, hopanoic, and steranoic acids, including parameter calculations derived from GC-MS and GC-MS/MS analyses, are absent. In fact, many studies use SPE, but many are applied to naphthenic acids, and with standards, not necessarily acid biomarkers. However, the proposal of the present method is based on the use of a Ca(OH)₂ modified phase, which has proven to be efficient in extraction not only in oil samples, but also in plant extracts, such as those obtained from Protium heptaphylum and Copaifera sp. This approach provides an innovative solution not explored in existing reviews.

The article entitled Carboxylic Acids in Petroleum: Separation, Analysis, and Geochemical Significance [25] that refers to common carboxylic acids containing oxygen compounds in oil samples has received attention in several areas, including petroleum geochemistry, petroleum processing, and petroleum pollution research. An essential aspect of the method described in the present application is the use of Ca(OH)₂ as a silica modifier usually employed in the extraction of carboxylic acids from complex samples. The Ca(OH)₂-modified stationary phase is superior not only in enabling the recovery of carboxylic acids in addition to naphthenic acids, but also in achieving higher yield and reproducibility, while providing molecular parameter values that are in better agreement with those obtained from independent analyses at a reference laboratory, as demonstrated in Tables 1 and 2 of the present application.

The higher recovery yield allows the analysis of samples with lower contents of carboxylic acid and acidic biomarkers, enabling the characterization of samples that would not otherwise be characterized due to the abundance of compounds.

It is worth noting that in the total ion chromatogram (TIC) of the derivatized acid fraction, several signals are resolved from the baseline. This is particularly important in isotope ratio analyses of specific compounds. Without a doubt, information regarding the isotope composition of carboxylic acids enabled access to a whole set of information of geochemical relevance. Furthermore, the derivatizing reagent employed results in quantitative conversion and introduces three carbon atoms into the structure, whereas other derivatizing reagents either (i) introduce fewer carbon atoms without a quantitative conversion, or require additional preparation steps until analysis by GC-MS (Gas Chromatography coupled to Mass Spectrometer) or (2) introduce six carbon atoms into the final structure, which makes the interpretation of the isotope data of the derivatized compounds difficult.

The present application further relates to the application of the Ca(OH)₂ modified phase in the recovery of carboxylic acids from less complex samples, such as plant extracts. The proposed method is based on the use of a Ca(OH)₂-modified phase, which has been shown to be efficient in the extraction not only in oil samples, but also in plant extracts, such as those derived from Protium heptaphylum and Copaifera sp.

Therefore, despite the contributions of the cited documents to the general understanding of the field, the present invention is distinguished by its specific and tangible contribution to obtaining carboxylic acid biomarkers in petroleum, sedimentary rocks and plant extracts using solid phase extraction with silica gel modified with calcium hydroxide (SiO₂/Ca(OH)₂), which broadens its scope and usefulness.

### SUMMARY OF THE DISCLOSURE

The present invention is intended to provide a method for extracting acidic biomarkers from oil samples and sedimentary rock extracts, or from other types of matrices, such as plant extracts, by means of solid phase extraction (SPE) using a calcium hydroxide-modified silica stationary phase at a concentration between 2 and 10% by weight. The main goal is to provide an extraction method that is efficient and on a smaller scale, significantly reducing the consumption of organic solvents, time and increasing the yield of the extraction process. This will contribute to a reduction in costs and environmental sustainability. Furthermore, the method can be adapted to the different features of oil samples, sedimentary rock extracts and plant extracts, ensuring an effective and accurate extraction of the acidic biomarkers present in each type of matrix.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The present invention will now be described with reference to FIGS. 1 to 25 which represent exemplary embodiments of the invention in a schematic and non-limiting.

FIG. 1 depicts an illustrative image of the species Protium heptaphyllum.

FIG. 2 depicts the chromatographic profile (GC-MS) of the acid fraction silylated with BSTFA (N,O-bis(trimethylsilyl)trifluoroacetamide) of mastic (Protium heptaphylum) resin.

FIG. 3 illustrates Copaifera sp., showing the process of oil collection.

FIG. 4 shows the chromatographic profile (GC-MS) of the acidic fraction (A) and crude oil (B), both from Copaifera langsdorffii Desf. The identified components are listed in Table 4.

FIG. 5 depicts the total ion chromatogram (GC-MS) of crude copaiba oil in (A), the acidic constituents (diterpenic acids) isolated on silica/Ca(OH)₂ in (B), and the partial TIC of the main acidic constituents identified, all as silylated derivatives.

FIG. 6 shows samples of non-biodegradable crude oils used for the extraction of acidic biomarkers.

FIG. 7 shows a sedimentary rock used for the extraction of acidic biomarkers: Araripe Basin-Barbalha Formation-Cretaceous.

FIG. 8 depicts the total ion chromatogram of acidic biomarkers extracted using a Ca(OH)₂-modified stationary phase.

FIG. 9 depicts the chromatograms of pentacyclic carboxylic acids obtained from the sedimentary rock of the Barbalha Formation, Cretaceous. Stationary phase modified with Ca(OH)₂.

FIG. 10 shows total ion chromatograms (TIC) of the acidic fractions of samples A, B and C obtained using stationary phases modified with KOH and Ca(OH)₂.

FIG. 11 represents mass m/z 132 chromatograms of the n-alkanoic acids in samples A, B and C extracted using stationary phases modified with KOH and Ca(OH)₂.

FIG. 12 depicts the mass chromatograms at m/z 355 and m/z 369, showing the phytanic and pristanic acids, respectively, in samples A, B, and C extracted using KOH- and Ca(OH)₂-modified stationary phases.

FIG. 13 depicts the mass chromatograms at m/z 123, showing the distribution of bicyclic terpenoic acids (BTA) in samples A, B, and C extracted using KOH- and Ca(OH)₂-modified stationary phases.

FIG. 14 depicts the mass chromatograms at m/z 191, showing the distribution of tricyclic terpenoic acids (TTA) in samples A, B, and C extracted using KOH- and Ca(OH)₂-modified stationary phases.

FIG. 15 shows mass chromatograms at m/z 333 showing the distribution of 3-carboxyalkylsteranes in samples A, B and C extracted using stationary phases modified with KOH and Ca(OH)₂.

FIG. 16 depicts the mass chromatograms at m/z 191, 293, 307, 321, 335, 349, and 363, showing the distribution of pentacyclic terpenoic acids (PTA) in the acidic fraction of Oil A extracted using the KOH-modified stationary phase.

FIG. 17 depicts the mass chromatograms at m/z 191, 293, 307, 321, 335, 349, and 363, showing the distribution of pentacyclic terpenoic acids (PTA) in the acidic fraction of Oil A extracted using the Ca(OH)₂-modified stationary phase.

FIG. 18 depicts the mass chromatograms at m/z 191, 293, 307, 321, 335, 349, and 363, showing the distribution of pentacyclic terpenoic acids (PTA) in the acidic fraction of Oil B extracted using the KOH-modified stationary phase.

FIG. 19 depicts the mass chromatograms at m/z 191, 293, 307, 321, 335, 349, and 363, showing the distribution of pentacyclic terpenoic acids (PTA) in the acidic fraction of Oil B extracted using the Ca(OH)₂-modified stationary phase.

FIG. 20 depicts the mass chromatograms at m/z 191, 293, 307, 321, 335, 349, and 363, showing the distribution of pentacyclic terpenoic acids (PTA) in the acidic fraction of Oil C extracted using the KOH-modified stationary phase.

FIG. 21 depicts the mass chromatograms at m/z 191, 293, 307, 321, 335, 349, and 363, showing the distribution of pentacyclic terpenoic acids (PTA) in the acidic fraction of Oil C extracted using the Ca(OH)₂-modified stationary phase.

FIG. 22 depicts the total ion chromatogram and the mass chromatogram at m/z 132, showing the presence of n-alkanoic acids in the acidic fraction of the organic extract from a FC rock (Parnaíba Basin, Aptian), extracted using the Ca(OH)₂-modified stationary phase.

FIG. 23 depicts the mass chromatograms at m/z 191, 205, 293, 307, 321, 335, 349, and 363, showing the distribution of hopanoic acids in the acidic fraction of the extract from a rock sample of Codó Formation, Parnaiba Basin, extracted using the Ca(OH)₂-modified stationary phase.

FIG. 24 depicts the mass chromatogram at m/z 333, 347, 473, 487, 501, 262, 276, and 98, showing the distribution of esterane carboxylic acids in the acidic fraction of the extract from a rock sample of the FC (Parnaíba Basin), extracted using the Ca(OH)₂-modified stationary phase.

FIG. 25 represents a profile showing the general abundance of some acidic compounds for oil A in different stationary phases.

### DETAILED DESCRIPTION OF THE DISCLOSURE

The present invention relates to a method of extracting acidic biomarkers present in oil samples, in extracts of sedimentary rocks and plant material consisting of the following steps:
(1) modifying silica with Ca(OH)₂ at a concentration between 2 and 10% by weight;
(2) assembling and packing the SPE cartridge;
(3) applying the sample followed by elution; and
(4) derivatizing with N,O-bis(trimethylsilyl)trifluoroacetamide (BSTFA) for analysis by gas chromatography-mass spectrometry.

Therefore, once the derivatization is complete, the sample is analyzed by GC-MS (Gas Chromatography coupled to a Mass Spectrometer).

The SiO₂/Ca(OH)₂ stationary phase, with a proposed concentration range between 2% and 10% by weight provides an effective solution by enabling higher recovery and thereby minimizing issues found in the extraction of acidic biomarkers from oil samples, sedimentary rock extracts, or bioactive compounds from plant extracts. This type of extraction is challenging, in particular for geological material, due to the low concentration of these compounds and the analytical complexity involved. Conventional methodology, such as Lewis base and solid phase extraction, often struggle to address these challenges, resulting in variable and less accurate responses depending on the matrix being analyzed.

Therefore, compared to conventional techniques, this new approach has been shown to provide more uniform and reproducible results, being applied to a small mass of samples. Furthermore, the SiO₂/Ca(OH)₂ phase allows a faster, more cost-effective and efficient extraction of acidic biomarkers, even in samples with low concentrations of these compounds. In biodegraded oil samples, for example, it can be applied to approximately 15 mg of oil, enabling the analysis of neutral (saturated, aromatic, heterocomponents) and acidic constituents. As will be evident from the examples and figures of the present invention, the results not only indicate the effectiveness of the proposed phase (SiO₂/Ca(OH)₂) in extracting acidic biomarkers from oil samples, sedimentary rock extracts and plant extracts, but also highlight its ability to address the analytical challenges faced by conventional methods.

It is also worth noting that silica is widely used in chromatography and in the separation of compounds, and its modification with KOH or Ca(OH)₂ increases the basicity of the silica surface. This change may result in stronger interactions with carboxylic acids. The stationary phases are composed of two different group IA (K) and group IIA (Ca) metals, having different pKa (basicity) and radii, which features strongly affect the ionic character of the stationary phase. Such a difference can be noted in practice in the data from Table 1 below.

Two key points that justify this variation can be noted: recovery/yield, which, with K, is only 37%, while with Ca it reaches 80%. There are significant differences in all parameters calculated when compared to three phases described in the literature (Tables 1 and 2).

When stationary phases are compared in the isolation of acids and one of them has twice the recovery, this has important implications for calculating molecular parameters (Tables 1 and 2). Tables 1 and 2 represent an acid fraction of the oil designated A, which is in the examples section of the present invention.

TABLE 1
Yields and quantification (in ppm of oil), based on the distribution of
compounds in the acidic fraction, used to interpret the data from the
acidic fraction of Oil A fractionated in different stationary phases.

| Yield | Reference (%)* | K (%) | Ca (%) | SAX (%) |
|---|---|---|---|---|
| Neutral Fraction | Not available | 89.00 | 87.90 | 90.00 |
| Acidic fraction | Not available | 2.10 | 2.40 | 3.90 |
| Standard | Not available | 37.08 | 79.78 | 1.76 |

| Compounds | Reference (ppm) | K (ppm) | Ca (ppm) | SAX (ppm) |
|---|---|---|---|---|
| n-C₁₆ | 11.87 | 17.98 | 21.46 | 59.26 |
| n-C₁₇ | 2.35 | 1.57 | 1.94 | 0.43 |
| n-C₁₈ | 3.08 | 13.20 | 17.52 | 43.02 |
| n-C₁₉ | 3.79 | 0.90 | 0.95 | 0.30 |
| n-C₂₀ | 7.62 | 1.96 | 2.17 | 0.75 |
| AcPri | 1.87 | 0.36 | 0.37 | 0.02 |
| AcFit | 1.87 | 0.74 | 0.76 | 0.04 |
| C21TTA | 12.08 | 7.83 | 7.86 | 0.11 |
| C₂₄ TTA S | 5.23 | 5.24 | 5.23 | 0.07 |
| C₂₄ TTA R | 5.55 | 5.70 | 5.64 | 0.34 |
| 17a21b S | 0.54 | 0.25 | 0.26 | 0.00 |
| 17a21b R | 0.32 | 0.18 | 0.20 | 0.00 |
| 17b21a S | n/a | 0.07 | 0.11 | 0.00 |
| 17b21a R | 0.11 | 0.17 | 0.20 | 0.00 |
| 17b21b S | 0.21 | 0.37 | 0.41 | 0.00 |
| 17b21b R | 0.08 | 0.22 | 0.21 | 0.00 |
| 25nor S | 0.18 | 0.12 | 0.09 | 0.00 |
| 25nor R | 0.04 | 0.03 | 0.05 | 0.00 |
| nC16 + C18 | 14.95 | 31.18 | 38.98 | 102.28 |
| nC17 + C19 + C20 | 13.76 | 4.43 | 5.06 | 1.48 |
| AcPri/AcFit | 1.00 | 0.48 | 0.49 | 0.50 |
| AcPri AcFit | 3.75 | 1.10 | 1.13 | 0.06 |
| Sum TTA | 22.86 | 18.77 | 18.74 | 0.53 |
| 25nors (Sum) | 0.23 | 0.15 | 0.13 | 0.00 |
| αβ(sum) | 0.86 | 0.43 | 0.47 | 0.00 |
| βα (sum) | 0.11 | 0.24 | 0.31 | 0.00 |
| Bβ (sum) | 0.29 | 0.59 | 0.62 | 0.00 |

TABLE 2
Ratios and key relationships based on the distribution
the distribution of compounds in the acidic fraction,
used to interpret the data from the acidic fraction of
Oil A fractionated in different stationary phases.

| | Reference* | | | |
|---|---|---|---|---|
| Ratios | (%) | K(%) | Ca(%) | SAX(%) |
| % nC17 + 19 + 20 | 32.88 | 17.24 | 19.14 | 71.63 |
| % iso | 8.95 | 4.29 | 4.28 | 2.95 |
| % Tric | 54.62 | 73.00 | 70.82 | 25.42 |
| %25-nors | 0.54 | 0.59 | 0.51 | 0.00 |
| % ab | 2.06 | 1.66 | 1.76 | 0.00 |
| % ba | 0.25 | 0.94 | 1.17 | 0.00 |
| % bb | 0.69 | 2.28 | 2.33 | 0.00 |

| Key relationships | Reference | K | Ca | SAX |
|---|---|---|---|---|
| 25-nor/(25-nor + ab-Hop) | 0.21 | 0.26 | 0.22 | n/a |
| bb-Hop/(bb-Hop + ab-Hop) | 0.25 | 0.58 | 0.57 | n/a |
| Tric/(Tri + n-Alc) | 0.62 | 0.81 | 0.79 | 0.26 |
| (25-nors + bb-Hop)/ | 0.03 | 0.13 | 0.12 | 0.00 |
| (25-nors + ab-Hop + bb-Hop + n-alc | | | | |

In Tables 1 and 2, K is the KOH-modified stationary phase; Ca is Ca(OH)₂-modified stationary phase; and SAX is the quaternary amine stationary phase. Regarding the reference* data, they correspond to an oil sample that was previously analyzed by the Laboratory of Biomarker Technologies, Inc., in the United States, under the Coordination of Prof. Mike Moldowan, PhD, which was taken as a reference sample for the development of the current studies.

When higher recovery is achieved using the Lewis base-modified stationary phase acid precipitation process, several important advantages are obtained:

### Accuracy:

A higher recovery means that a larger amount of the analyte (e.g., an acidic biomarker) is recovered after separation.
That is crucial for quantitative analyses, where accuracy in determining concentration is essential.
With a higher recovery, the quantitative results are more reliable and accurate.

### Separation Efficiency:

A stationary phase with high recovery rate allows better separation of sample components.
Chromatographic peaks are sharper and better defined, making the identification and quantification of analytes easier.
This is especially important when peaks overlap or when the components are very similar in structure.

### Saving Time and Resources:

A higher recovery rate means less sample is lost during the separation process.
This saves time and resources as there is no need to repeat the analysis or prepare additional samples.

### Better Detectability:

A higher recovery rate enables the detection of lower concentrations of the analyte.
This is crucial for trace analysis or when sample mass is limited.

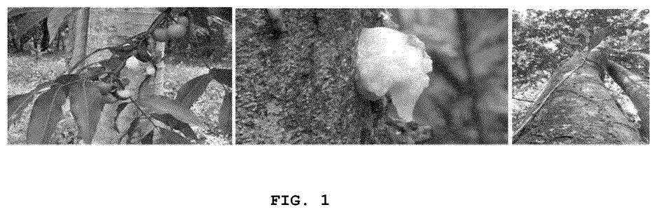

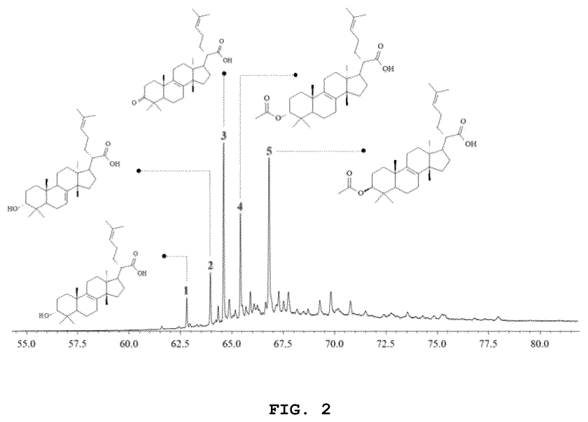

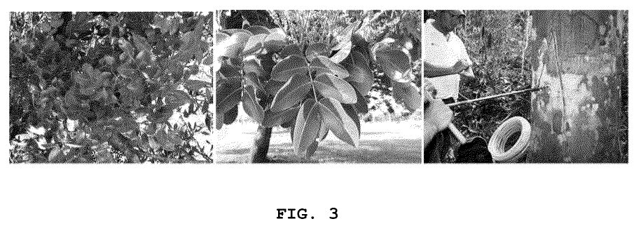

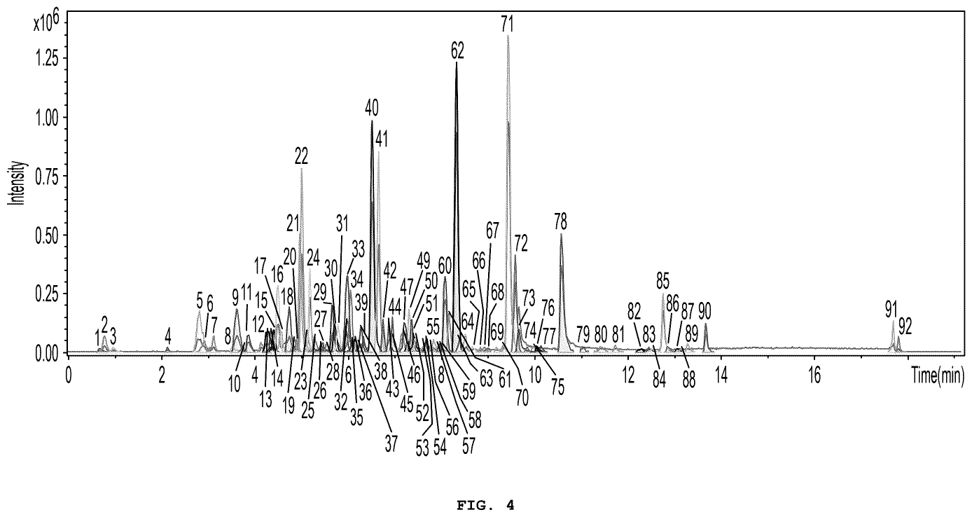

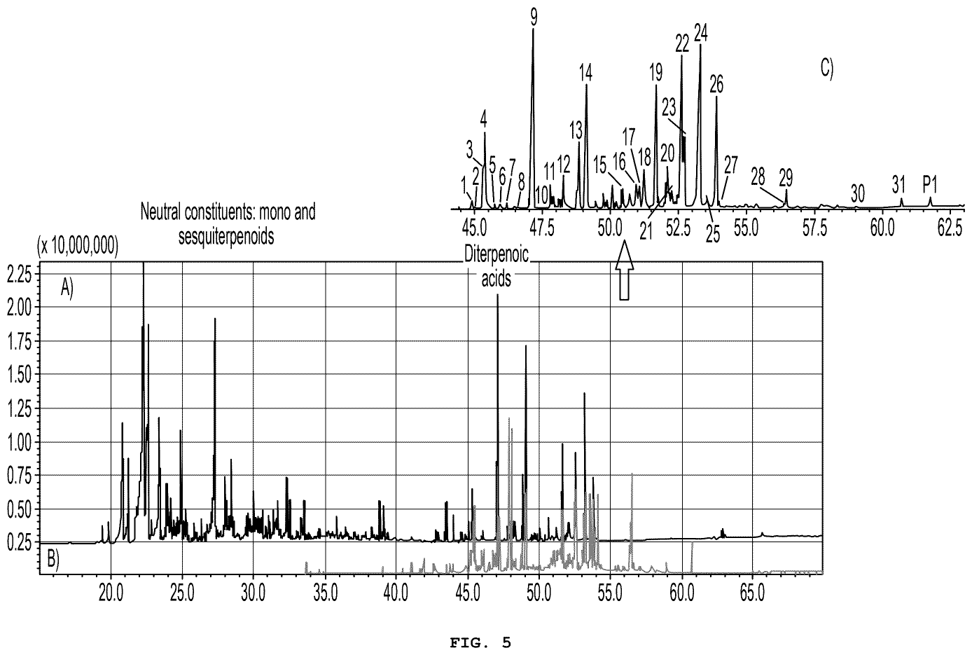

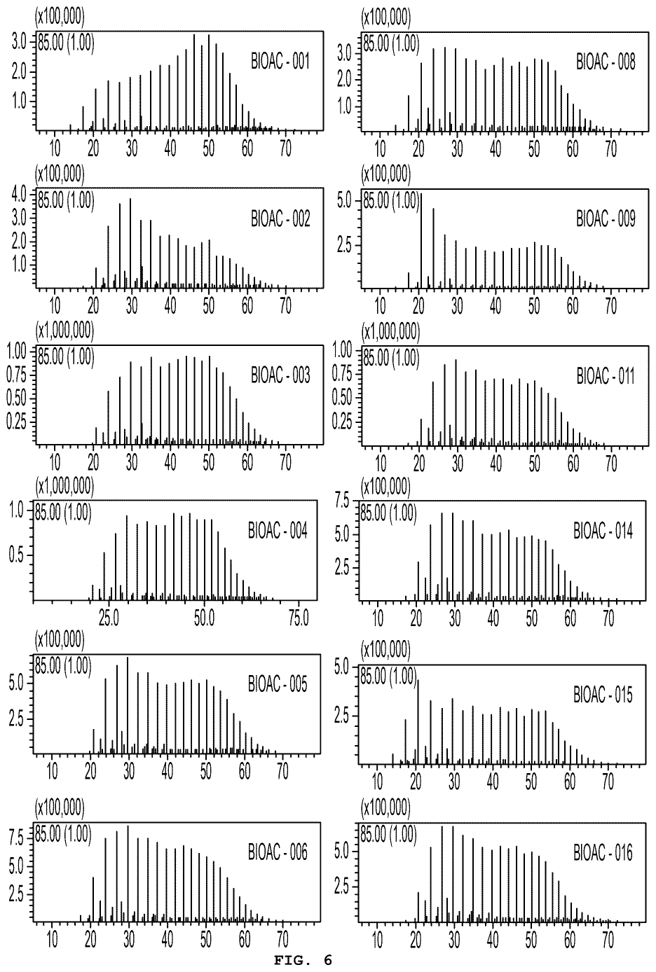

It is important to emphasize that the method of the present invention extends to materials of plant origin, as exemplified by extracts of mastic resin (Protium heptaphylum-represented in the image of FIG. 1 and in the chromatographic profile of FIG. 2) and the fixed oil of Copaifera sp (represented in the image in FIG. 3, in the chromatographic profiles in FIGS. 4 and 5). Table 3 further represents the compounds detected in the acidic fraction of copaiba obtained via the methodology of silica/Ca(OH)₂ fractionation. Table 4 shows the main compounds identified by Liquid Chromatography coupled to Mass Spectrometry (LC-MS) in the acidic fraction extracted from Copaiba oil.

TABLE 3
Compounds detected in the acidic fraction of copaiba obtained via the methodology of silica/
Ca(OH)₂ fractionation. Derivatized with BSTFA and analyzed as trimethylsilyl esters.

| No.: | Compound | Formula | MM | MM* |
|---|---|---|---|---|
| 1 | 3,13-Clerodadiene-15-oic acid (Colavenic acid) | C₂₀H₃₂O₂ | 304 | 376 |
| 2 | (13S)-7-labden-15-oic acid (cativic acid) or | C₂₀H₃₄O₂ | 306 | 378 |
| | ent-8(17)-labden-15-oic acid (eperuic acid) | | | |
| 3 | (13S)-7-labden-15-oic acid (cativic acid) or | C₂₀H₃₄O₂ | 306 | 378 |
| | ent-8(17)-labden-15-oic acid (eperuic acid) | | | |
| 4 | (13S)-7-labden-15-oic acid (cativic acid) or | C₂₀H₃₄O₂ | 306 | 378 |
| | ent-8(17)-labden-15-oic acid (eperuic acid) | | | |
| 5 | (13S)-7-labden-15-oic acid (cativic acid) or | C₂₀H₃₄O₂ | 306 | 378 |
| | ent-8(17)-labden-15-oic acid (eperuic acid) | | | |
| 6 | (13S)-7-labden-15-oic acid (cativic acid) or | C₂₀H₃₄O₂ | 306 | 378 |
| | ent-8(17)-labden-15-oic acid (eperuic acid) | | | |
| 7 | 3,13-Clerodadiene-15-oic acid (Colavenic acid) | C₂₀H₃₂O₂ | 304 | 376 |
| 8 | 3,13-Clerodadiene-15-oic acid (Colavenic acid) | C₂₀H₃₂O₂ | 304 | 376 |
| 9 | 8(17),13E-labdadien-15-oic acid (Copaiferic acid) or | C₂₀H₃₂O₄ | 304 | 376 |
| | ent-8(17)-13E-labdadien-15-oic acid (copalic acid) | | | |
| 10 | 8(17),13E-labdadien-15-oic acid (Copaiferic acid) or | C₂₀H₃₂O₂ | 304 | 376 |
| | Ent-8(17)-13E-labdadien-15-oic acid (Copalic acid) | | | |
| 11 | 8(17),13E-labdadien-15-oic acid (Copaiferic acid) or | C₂₀H₃₂O₂ | 304 | 376 |
| | ent-8(17)-13E-labdadien-15-oic acid (copalic acid) | | | |
| 12 | 8(17),13E-labdadien-15-oic acid (Copaiferic acid) or | C₂₀H₃₂O₂ | 304 | 376 |
| | ent-8(17)-13E-labdadien-15-oic acid (copalic acid) | | | |
| 13 | ent-15,16-epoxy-13(16),14-clerodadien-18-oic acid (Chlorechinic acid) | C₂₀H₃₀O₃ | 318 | 390 |
| 14 | ent-15,16-epoxy-3,13(16),14-clerodatrien-18-oic acid (Hardwickiic | C₂₀H₂₈O₃ | 316 | 388 |
| | acid) or | | | |
| | ent-15,16-epoxy-8(17),13(16),14-labdatrien-18-oic acid (Polyaltic | | | |
| | acid) | | | |
| 15 | ent-16-b-cauran-19-oic acid | C₂₀H₃₂O₂ | 304 | 376 |
| 16 | 3-clerodene-15,18-dioic acid or | C₂₀H₃₂O₄ | 336 | 390 |
| | ent-8(17)-labdene-15,18-dioic acid (Eperu-8(20)-15,18-dioic acid) | | | |
| 17 | ent-caura-16-en-19-oic acid | C₂₀H₃₀O₂ | 302 | 374 |
| 18 | 18-hydroxy-8(17),13-labdadien-15-oic acid (Copaiferolic acid) or | C₂₀H₃₂O₃ | 320 | 464 |
| | ent-15,16-epoxy-8(17),13(16),14-labdatrien-18-oic acid (Polyaltic | | | |
| | acid) | | | |
| 19 | Clerodane-15,18-dioic acid | C₂₀H₃₄O₄ | 338 | 482 |
| 20 | 3-clerodene-15,18-dioic acid or | C₂₀H₃₂O₄ | 336 | 390 |
| | ent-8(17)-labdene-15,18-dioic acid (Eperu-8(20)-15,18-dioic acid) | | | |
| 21 | Unidentified | C₂₀H₃₀O₄ | 334 | 478 |
| 22 | Ent-8(17),13-labdadiene-15,19-dioic-8(17),13-labdadiene-15,19-dioic | C₂₀H₃₀O₄ | 334 | 478 |
| | acid (ent-agatic acid) | | | |
| 23 | 18-hydroxy-8(17),13-labdadien-15-oic acid (Copaiferolic acid) or | C₂₀H₃₂O₃ | 320 | 464 |
| | ent-15,16-epoxy-8(17),13(16),14-labdatrien-18-oic acid (Polyaltic | | | |
| | acid) | | | |
| 24 | ent-11-acetoxy-8(17)-13E-labdadiene-15-oic acid (11-acetoxy-copalic | C₂₂H₃₄O₄ | 362 | 434 |
| | acid) | | | |
| 25 | Ent-8(17),13-labdadiene-15,19-dioic acid (Ent-agatic acid) | C₂₀H₃₀O₄ | 334 | 478 |
| 26 | Unidentified | — | — | — |
| 27 | 3β-Acetoxypallic acid | C₂₂H₃₄O₄ | 362 | 434 |
| 28 | Unidentified | — | — | — |
| 29 | 7-Hydroxypatagonic acid | C₂₀H₂₈O₅ | 348 | 492 |
| 30 | Unidentified | — | — | — |
| 31 | 1,2-ehydropatagonic acid | C₂₀H₂₆O₄ | 330 | 402 |
| I.S. | Internal standard (lithocholic acid) | C₂₄H₄₀O₃ | 376 | 520 |

MM, Molar mass; MM*, molar mass of the silylated derivative.

TABLE 4
Main compounds identified by LC-MS in the
acidic fraction extracted from Copaiba oil.

| | | Relative | | | |
|---|---|---|---|---|---|
| | RT | Abundance | | | Molecular |
| Number | (min) | (%) | [M − H]⁻ | Proposed compound^{a} | Formula |
| 3 | 3.0 | 0.1 | 361.1649 | Acetoxycopalic acid | C₂₀H₂₆O₆ |
| | | | | (isomer) | |
| 5 | 3.6 | 0.1 | 361.1665 | Acetoxycopalic acid | C₂₀H₂₆O₆ |
| | | | | (isomer) | |
| 7 | 3.7 | 0.2 | 363.1790 | 3β-Acetoxy-13,14-dihydrocopalic | C₂₀H₂₈O₆ |
| | | | | acid | |
| 8 | 3.8 | 0.2 | 347.1848 | Hydroxypatagonic acid | C₂₀H₂₈O₅ |
| | | | | (isomer) | |
| 10 | 4.2 | 0.1 | 349.1998 | 3,4-Dihydro-7-hydroxypatagonic | C20H30O5 |
| | | | | acid | |
| 17 | 5.0 | 1.2 | 349.2010 | 3,4-Dihydro-7-hydroxypatagonic | C20H30O5 |
| | | | | acid | |
| 18 | 5.0 | 2.6 | 347.1870 | Hydroxypatagonic acid | C₂₀H₂₈O₅ |
| | | | | (isomer) | |
| 19 | 5.1 | 1.6 | 389.1974 | 7-Acetoxypatagonic acid | C₂₂H₃₀O₆ |
| 21 | 5.2 | 0.2 | 345.1691 | 1,2-Dehydro-7- | C₂₀H₂₆O₅ |
| | | | | Hydroxypatagonic acid | |
| 23 | 5.4 | 0.6 | 329.1749 | 1,2-Dehydropatagonic acid | C₂₀H₂₆O₄ |
| 24 | 5.4 | 0.5 | 331.1901 | Patagonic acid or 7- | C₂₀H₂₈O₄ |
| | | | | hydroxyhardwickiic acid | |
| 25 | 5.4 | 0.4 | 333.2053 | Colavenic acid, | C₂₀H₃₀O₄ |
| | | | | ent-agatic acid, | |
| | | | | Agatic acid, | |
| | | | | ent-8(17)-labdene-15,19-dioic acid, | |
| | | | | Eperu-8(20)-15,18-dioic acid or | |
| | | | | Colavic acid | |
| 27 | 5.6 | 0.6 | 329.1735 | 1,2-Dehydropatagonic acid | C₂₀H₂₆O₄ |
| 29 | 5.6 | 0.9 | 333.2056 | Colavenic acid, | C₂₀H₃₀O₄ |
| | | | | ent-agatic acid, | |
| | | | | Agatic acid, | |
| | | | | ent-8(17)-labdene-15,19-dioic acid, | |
| | | | | Eperu-8(20)-15,18-dioic acid or | |
| | | | | Colavic acid | |
| 30 | 5.7 | 5.9 | 331.1927 | Patagonic acid or | C₂₀H₂₈O₄ |
| | | | | 7-hydroxyhardwickiic acid | |
| 31 | 5.8 | 0.7 | 317.2098 | 8,17-Dihydropolyaltic Acid or | C₂₀H₃₀O₃ |
| | | | | Crolechinic acid | |
| 34 | 6.0 | 0.4 | 333.2053 | Colavenic acid, | C₂₀H₃₀O₄ |
| | | | | Ent-agatic acid, | |
| | | | | Agatic acid, | |
| | | | | ent-8(17)-labdene-15,19-dioic acid, | |
| | | | | Eperu-8(20)-15,18-dioic acid or | |
| | | | | Colavic acid | |
| 35 | 6.0 | 0.9 | 331.1915 | Patagonic acid or | C₂₀H₂₈O₄ |
| | | | | 7-hydroxyhardwickiic acid | |
| 38 | 6.2 | 0.2 | 333.2055 | Colavenic acid, | C₂₀H₃₀O₄ |
| | | | | ent-agatic acid, | |
| | | | | Agatic acid, | |
| | | | | ent-8(17)-labdene-15,19-dioic acid, | |
| | | | | Eperu-8(20)-15,18-dioic acid or | |
| | | | | Colavic acid | |
| 40 | 6.3 | 2.0 | 317.2125 | 8,17-Dihydropolyaltic Acid or | C₂₀H₃₀O₃ |
| | | | | Crolechinic acid | |
| 42 | 6.5 | 0.3 | 319.2266 | 3β-hydroxycopalic acid, | C₂₀H₃₂O₃ |
| | | | | 3β-alepterolic acid, | |
| | | | | 3α-alepterolic acid or | |
| | | | | Copaiferolic Acid | |
| 43 | 6.6 | 4.5 | 333.2081 | Colavenic acid, | C₂₀H₃₀O₄ |
| | | | | ent-agatic acid, agatic acid, | |
| | | | | ent-8(17)-labdene-15,19-dioic acid, | |
| | | | | Eperu-8(20)-15,18-dioic acid or | |
| | | | | Colavic acid | |
| 44 | 6.7 | 2.9 | 337.2382 | clerodane-15,18-dioic acid | C₂₀H₃₄O₄ |
| 45 | 6.8 | 3.2 | 333.2079 | Colavenic acid, | C₂₀H₃₀O₄ |
| | | | | Agatic acid, | |
| | | | | ent-agatic acid, | |
| | | | | ent-8(17)-labdene-15,19-dioic acid, | |
| | | | | Eperu-8(20)-15,18-dioic acid or | |
| | | | | Colavic acid | |
| 46 | 6.9 | 0.5 | 335.2211 | Pinifolic Acid, | C₂₀H₃₂O₄ |
| | | | | ent-3β,18-dihydroxy-8(17),13- | |
| | | | | labdadien-15-oico acid, | |
| | | | | Clerod-3-ene-15,18-dioic acid, | |
| | | | | ent-8(17)-labdane-15,18-dioic acid, | |
| | | | | ent-pinifolic acid or | |
| | | | | (4R,5β,9β,10α)-labd-8(20)-ene- | |
| | | | | 15,18-dioic acid | |
| 48 | 7.0 | 1.1 | 317.2108 | 8,17-Dihydropolyaltic Acid or | C₂₀H₃₀O₃ |
| | | | | Crolechinic acid | |
| 52 | 7.2 | 0.8 | 319.2276 | 3β-Hydroxycopalic acid, | C₂₀H₃₂O₃ |
| | | | | 3β-Alepterolic acid, | |
| | | | | 3α-Alepterolic acid or | |
| | | | | Copaiferolic Acid | |
| 53 | 7.3 | 0.3 | 361.2365 | Alepterolic acid acetate | C₂₂H₃₄O₄ |
| 54 | 7.3 | 1.7 | 373.2027 | 7-acetoxyhardwickiic acid | C₂₂H₃₀O₅ |
| 59 | 7.6 | 0.7 | 319.2274 | 3β-hydroxycopalic acid, | C₂₀H₃₂O₃ |
| | | | | 3β-Alepterolic acid, | |
| | | | | 3α-alepterolic acid or | |
| | | | | Copaiferolic Acid | |
| 63 | 7.9 | 5.2 | 347.2238 | Agatic acid 15-methyl ester | C₂₁H₃₂O₄ |
| 64 | 8.0 | 0.9 | 361.2377 | Alepterolic acid acetate (isomer) | C₂₂H₃₄O₄ |
| 65 | 8.1 | 5.2 | 315.1975 | Polyaltic Acid, | C₂₀H₂₈O₃ |
| | | | | (−)-Hardwickiic, | |
| | | | | (+)-Hardwickiic or | |
| | | | | Lambertian | |
| 66 | 8.2 | 1.9 | 317.2122 | 8,17-Dihydropolyaltic Acid or | C₂₀H₃₀O₃ |
| | | | | Crolechinic acid | |
| 67 | 8.4 | 8.5 | 361.2391 | Alepterolic acid acetate | C₂₂H₃₄O₄ |
| 70 | 8.8 | 1.4 | 303.2333 | Copaiferic acid, | C₂₀H₃₂O₂ |
| | | | | Copalic acid, | |
| | | | | ent-copalic acid or | |
| | | | | Kauranoic acid | |
| 71 | 8.9 | 0.1 | 363.2511 | 15.18 | C₂₂H₃₆O₄ |
| | | | | Labd-8(20)-ene- | |
| | | | | dioic acid | |
| 73 | 19.0 | 0.9 | 303.2326 | Copaiferic acid, | C₂₀H₃₂O₂ |
| | | | | Copalic acid, | |
| | | | | ent-copalic acid or | |
| | | | | Kaurenoic acid | |
| 76 | 9.2 | 2.0 | 303.2336 | Copaiferic acid, | C₂₀H₃₂O₂ |
| | | | | Copalic acid, | |
| | | | | ent-copalic acid or | |
| | | | | Kaurenoic acid | |
| 77 | 9.5 | 9.8 | 303.2337 | Copaiferic acid, | C₂₀H₃₂O₂ |
| | | | | Copalic acid, | |
| | | | | ent-copalic acid or | |
| | | | | Kaurenoic acid | |
| 78 | 9.6 | 3.7 | 305.2490 | Cathyvic Acid or | C₂₀H₃₄O₂ |
| | | | | eperuic acid | |
| 79 | 9.7 | 4.4 | 305.2493 | Cathyvic Acid or | C₂₀H₃₄O₂ |
| | | | | eperuic acid | |
| 80 | 10.0 | 0.6 | 307.2631 | 8,17-Dihydroeperuic acid | C20H36O2 |
| 82 | 10.1 | 0.2 | 283.2625 | Octadecanoic acid | C18H36O2 |

^{a}For several of the compounds more than one name is given. In such cases the names should be understood as being the various possibilities.

It is worth noting that in the chromatographic profile of FIG. 5, the complex sample presented in chromatographic profile “A”, which is rich in hundreds of compounds, including neutral diterpenes, diterpenoids, ketones, esters, among others, and also carboxylic acids. In part “B” is the chromatographic profile of only the isolated acids, with an enlarged profile presented in “C”.

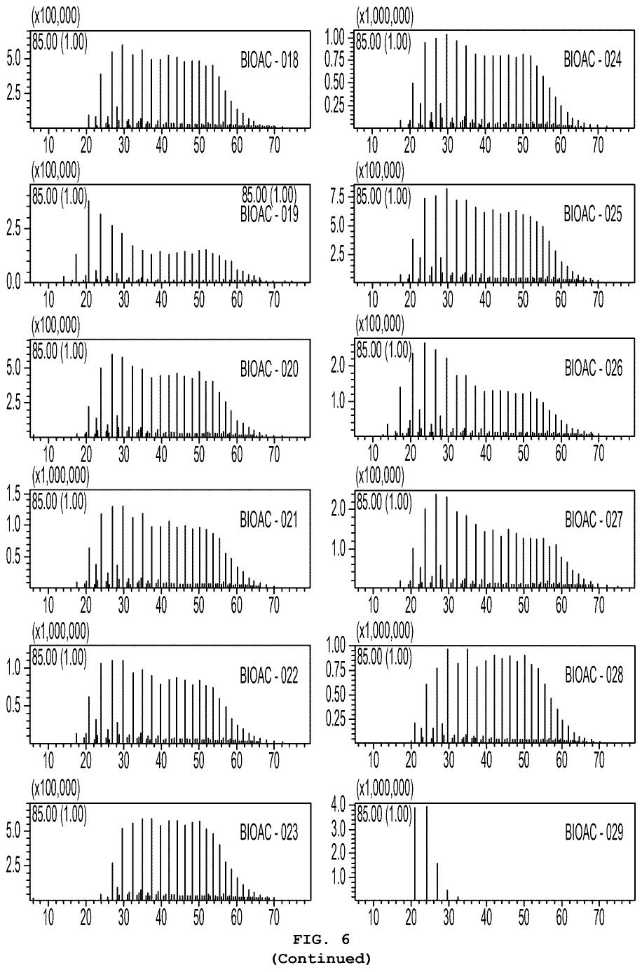

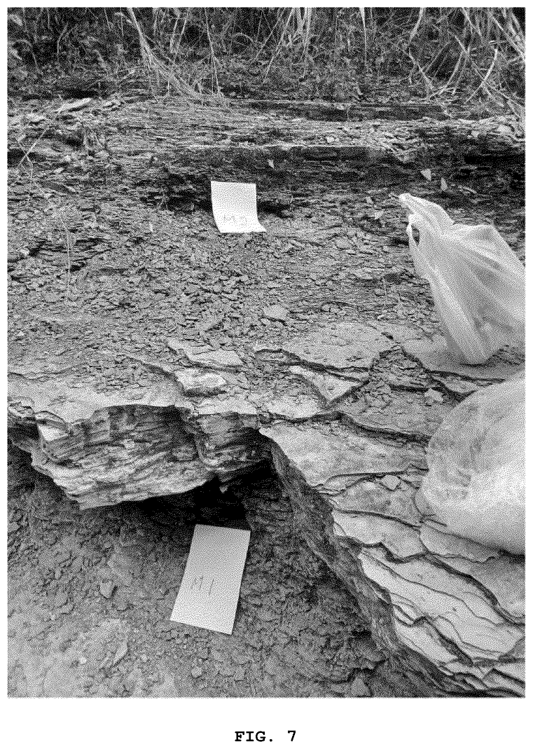

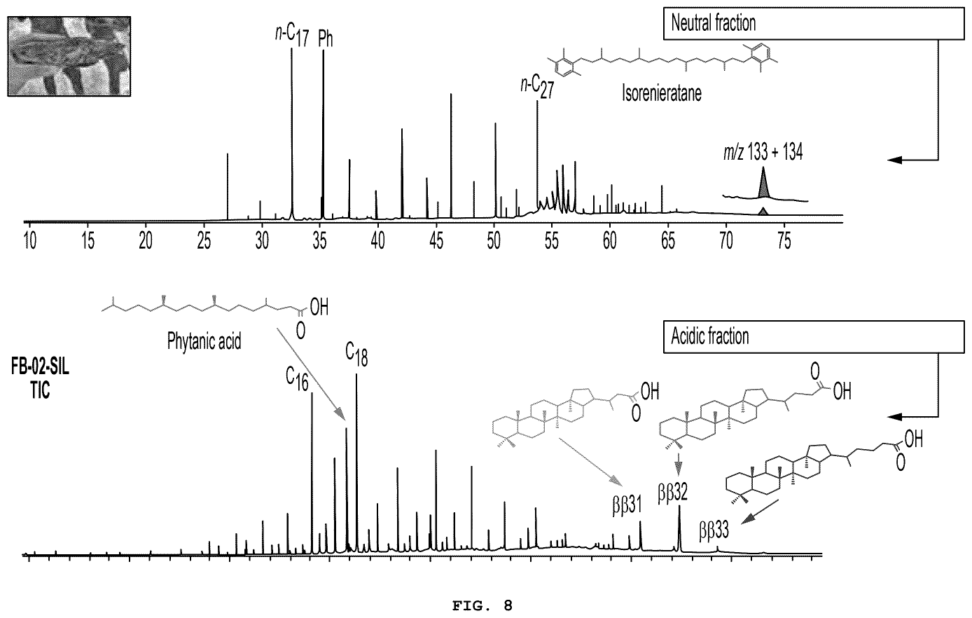

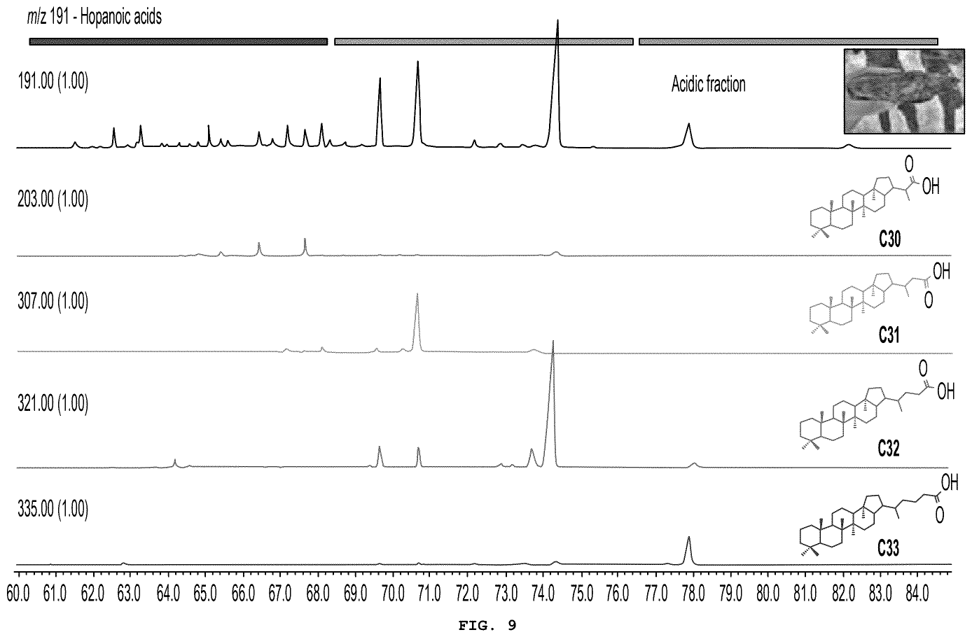

FIG. 6 depicts the extraction of acids applied to 29 extremely complex samples of non-biodegradable oils, wherein the acidic biomarker content is very low. For some samples, only 20 mg of crude oil was required, which was sufficient to assess the saturated, aromatics, heterocomponents and carboxylic acids. FIG. 6 shows the profiles of the samples analyzed. There is certainly nothing in the literature with such expressive results showing such well-defined profiles with less recovery. It is worth noting that all these samples were analyzed only with the Ca(OH)₂ modified phase, because of the low recovery it would not be possible to achieve the same results using other types of modified phases, for example, KOH. The stationary phase provides expressive results for extracting acids from rock samples with low Total Organic Carbon (TOC) from any geological period.

In order to better define the invention, the following are examples of embodiments and tests of the present invention. Obviously, the following data are exemplary and not exhaustive and are intended to better illustrate the operation of the present invention. Other embodiments may be envisioned that are not expressly described herein; however, a person skilled in the art will recognize that modifications and adjustments can be made without departing from the scope of the present invention.

### Exemplary Embodiment/Tests and Results

The components of the invention are mainly related to the method described below, from the preparation of modified Ca(OH)₂ to the interpretation and analysis of the data, namely: Steps of the extraction method using SPE cartridge-type mini columns.

In step 1, Ca(OH)₂ was dissolved in isopropanol in an Erlenmeyer flask until completely dissolved. The isopropanol-Ca(OH)₂ suspension had a concentration of 50 mg/mL. Silica heated to 600° C. was gradually added to the suspension, with stirring for 15 minutes. It was homogenized in ultrasound for 8 minutes and manually for an additional 1 minute. After resting for 1 hour, the mixture was vacuum filtered using a Büchner funnel and vacuum filtration flask. The silica/Ca(OH)₂ phase at a concentration between 2 and 10% by weight was activated in a vacuum oven for 2 hours at 100° C.

In step 2, 7 g of the stationary phase modified with Ca(OH)₂ were used and transferred to a glass cartridge (20 mm in diameter). The cartridges were coupled to a vacuum filtration flask and eluted 3 times with 10 mL of ethyl ether to clean and pack the stationary phase.

In step 3, the samples were doped with 5.0 μg ibuprofen and 2.5 μg homopregnanic acid before application to the SPE cartridge. The prepared samples were applied to the top of the stationary phase of the cartridge, followed by 500 to 800 mg of sodium sulfate (Na₂SO₄). For elution, 100 mL of ethyl ether was used to obtain fraction 01 (Fr1) containing saturated and aromatic hydrocarbons, and 100 mL of ethyl ether and 2-6% formic acid to obtain fraction 02 (Fr2) containing carboxylic acids. A vacuum filtration flask and a vacuum pump were used to increase the elution speed. The same procedure was applied to a sample from the Codó Formation, Parnaiba Basin, using about 65 mg rock extract.

In step 4, 4.0 mg to 7.0 mg of the acidic fraction (Fr2) of each sample were used for derivatization. The same masses of ibuprofen and homopregnanic acid used in doping the samples were used for the unprocessed standards. The samples were added to a 5 mL round-bottom flask cleaned with dichloromethane and containing a magnetic bar. Pyridine and BSTFA (N,O-bis(trimethylsilyl)trifluoroacetamide) were added in a 1:1 (v/v) ratio, at a rate of 1 mg of fraction per each 50 μL BSTFA and 50 μL pyridine. The derivatization flask was placed in a sand bath system with a thermometer under a heating plate, maintaining the temperature between 50° C. and 70° C. for 1 h and 30 min. Once the derivatization was completed, the sample was analyzed by GC-MS.

To extract acids from plant material, plant extract samples were prepared following standard procedures for carboxylic acids. The sample was applied to the top of the stationary phase of the SPE cartridge, as per the protocol used for oil samples and rock extracts. Alternatively, extraction can be performed by the Soxhlet method [13 and 14], using the ratio of materials to solvents mentioned above.

### Evaluation of the Efficiency of the Extraction Method Using SPE Cartridge Mini Columns.

To assess efficiency of the extraction method using SPE cartridge mini columns, samples A, B and C were subjected to extraction in cartridges with KOH- and Ca(OH)₂-modified silica.

The following data was analyzed: chromatographic profile, yield, solvent volume, stationary phase mass, sample mass used and a comparison with data from a reference oil sample analyzed by the US Research Laboratory of Biomarker Technologies, Inc., under the coordination of Prof. Mike Moldowan, phD.

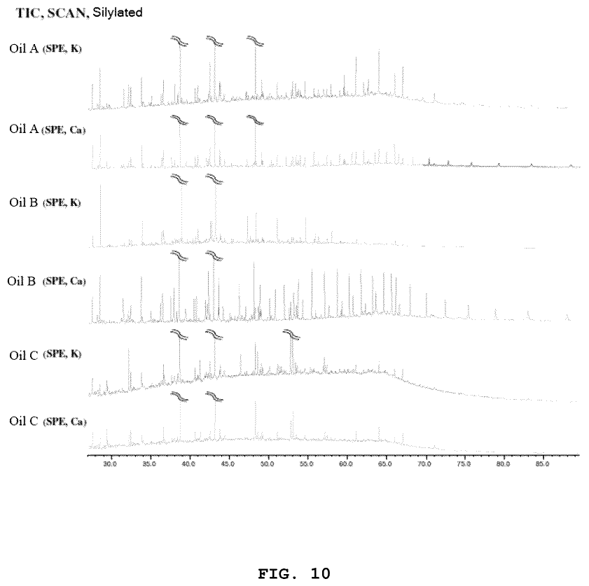

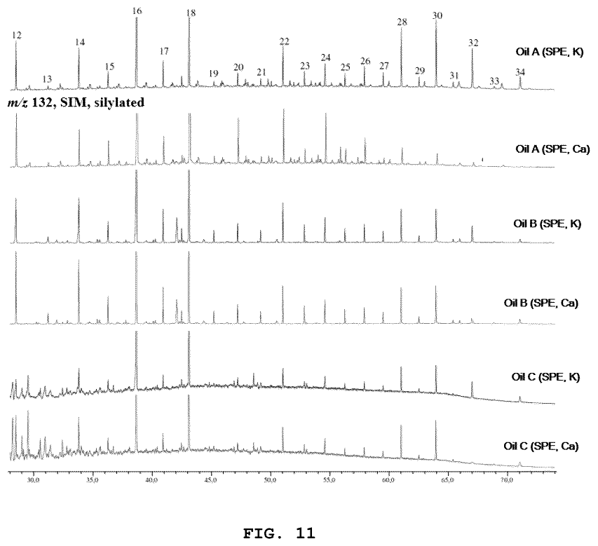

n-alkanoic acids: A predominance of hexadecanoic (palmitic, 16:0) and octadecanoic (stearic, 18:0) acids was observed in all samples (FIGS. 10 and 11).

C16 and C18 fatty acids must be used with caution due to a possible contamination from the ingredients used when carrying out the experiment, such as solvents, reagents, etc.

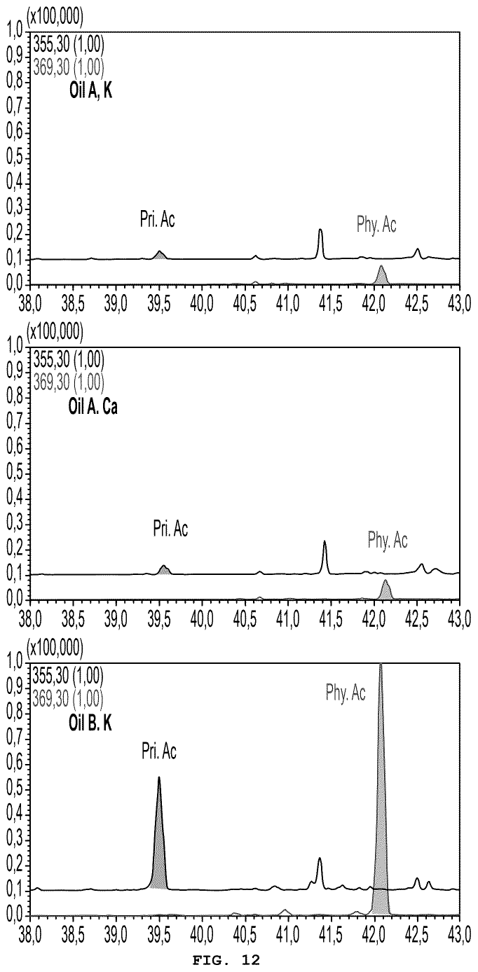

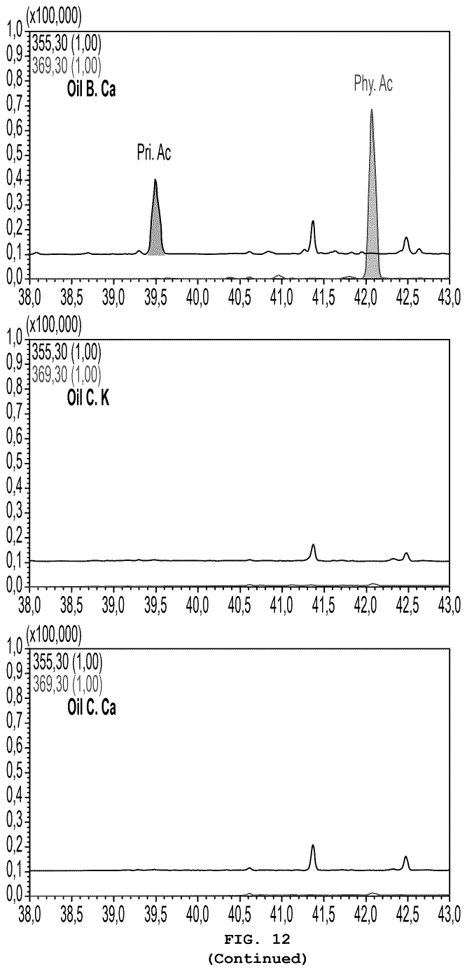

Acyclic isoprenoid acids: The abundance of acyclic isoprenoid acids, mainly pristanic and phytanic acids, was shown to vary significantly between the samples. Sample A has low abundance, B has high levels and C has even lower levels (FIG. 12).

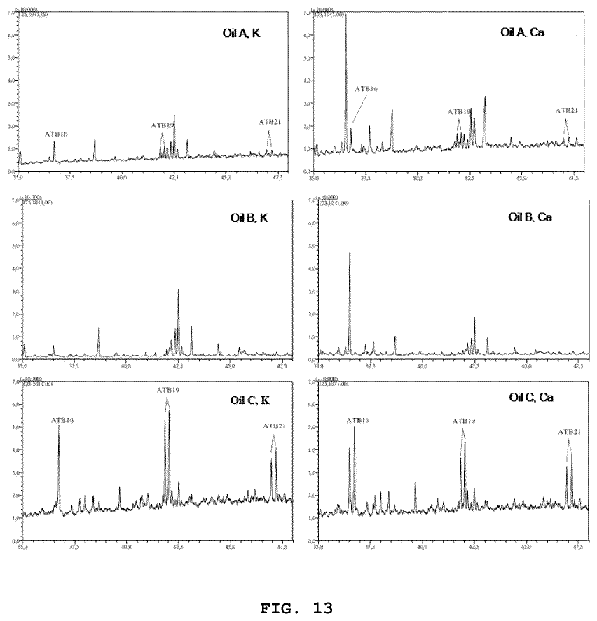

Bicyclic terpanoic acids: Compounds with a labdane skeleton were identified in the mass chromatogram at m/z 123 (FIG. 13).

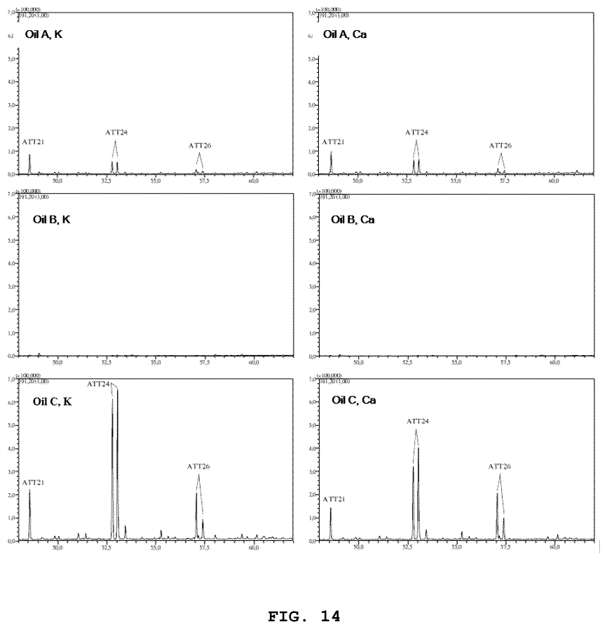

Tricyclic terpanoic acids: Tricyclic terpanoic acids (TTA) were shown in the acidic fractions of samples A and C (FIG. 14). These compounds are common in the acidic fractions of crude oils.

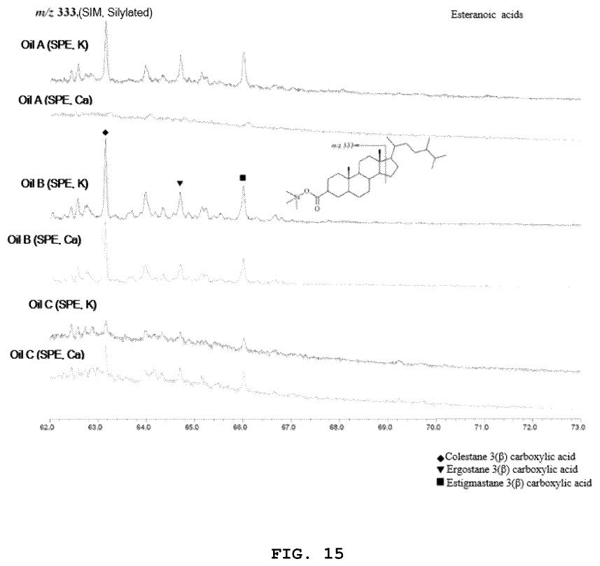

Tetracyclic terpanoic acids: A series of tetracyclic terpanoic acids (TTAs) were detected in the acidic fractions of the three samples, identified as 3-carboxyalkylsteranes (FIG. 15). Sample B has the greatest abundance and complexity of these compounds.

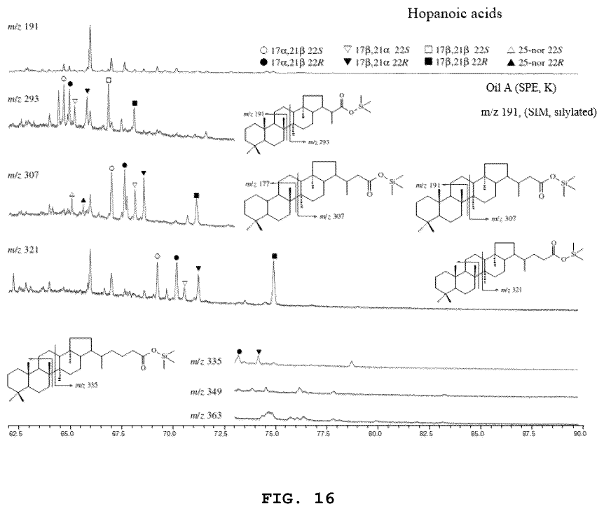

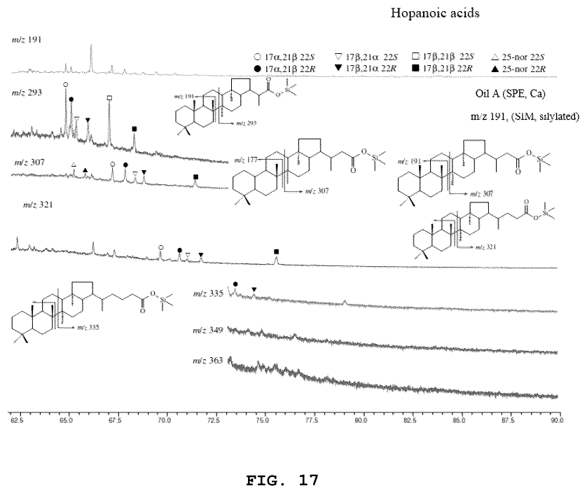

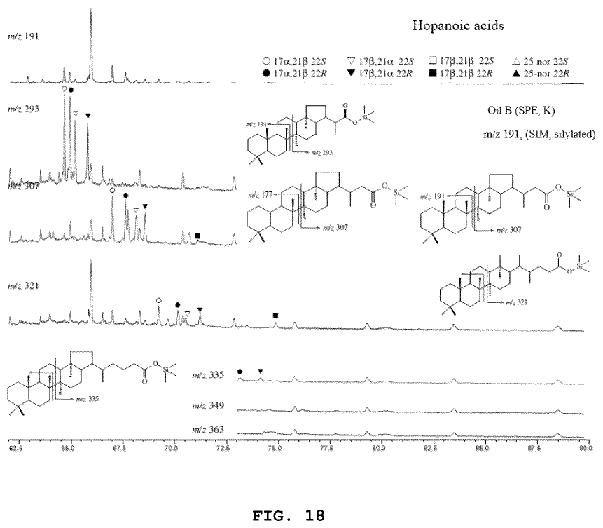

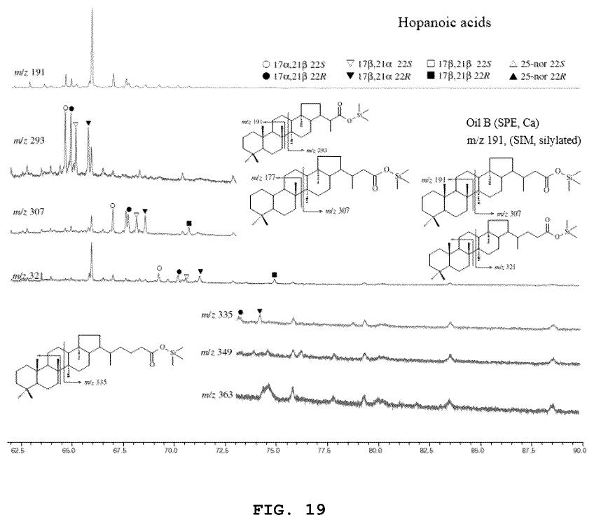

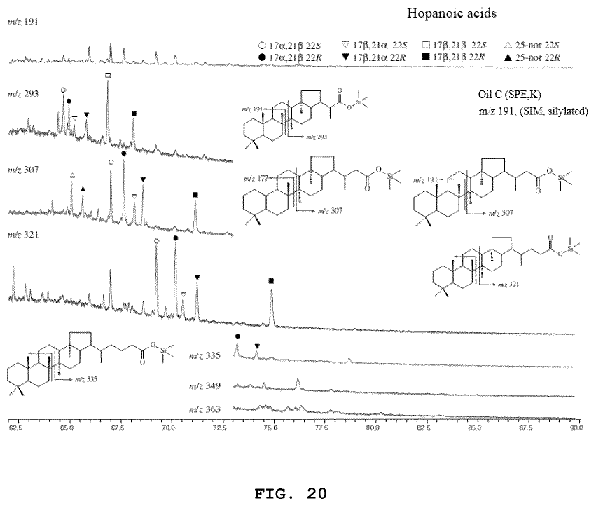

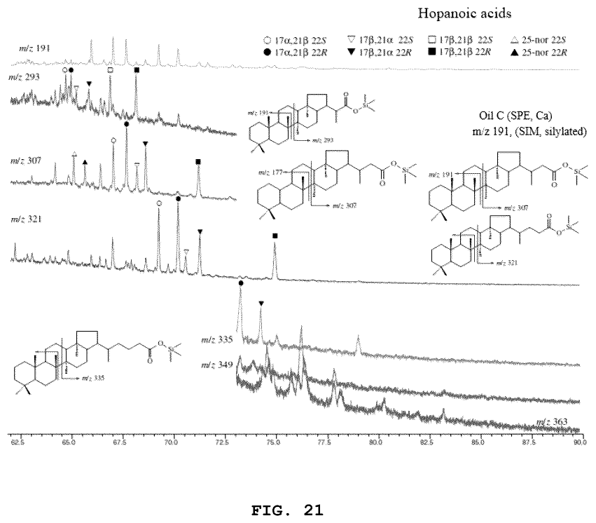

Pentacyclic terpanoic acids: A pseudo-homologous series of pentacyclic terpanoic acids (TPAs) was detected in the acidic fractions of three samples (FIGS. 16 to 21), identified as hopanoic acids in the range of from C30 to C33. Two C31 25-nor-hopanoic acids were identified, with greater relative abundance in sample C (FIGS. 20 and 21).

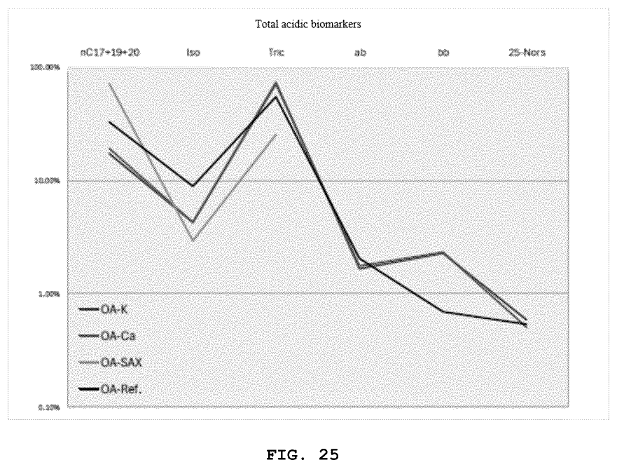

Quantification of acidic compounds: Table 1 shows the quantification of the identified acidic compounds, the values being semi-quantitative. Table 2 shows key relationships used in interpreting the distribution of carboxylic acids, with the general trend of the parameters presented in FIG. 25.

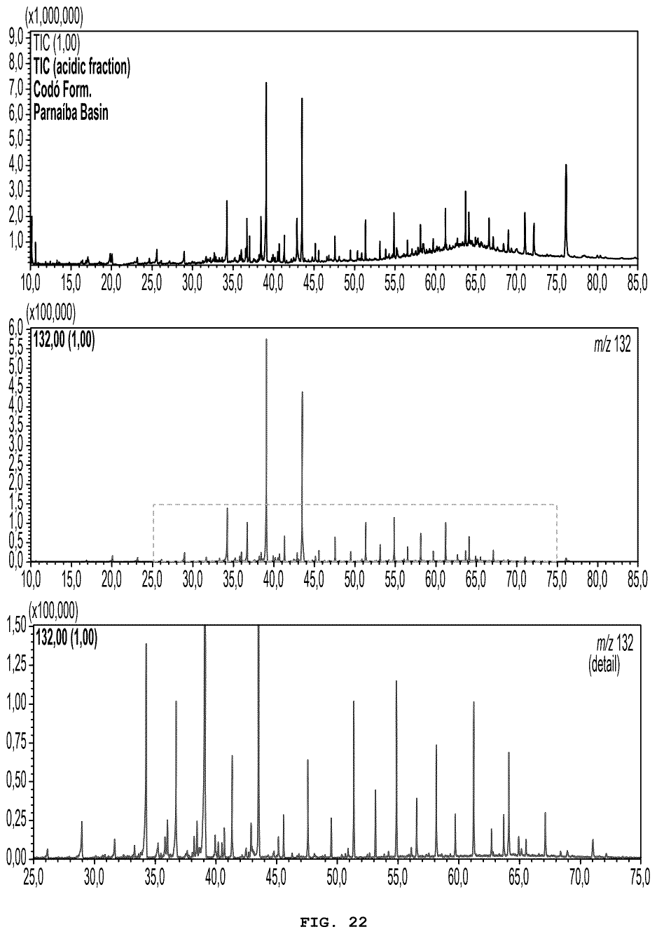

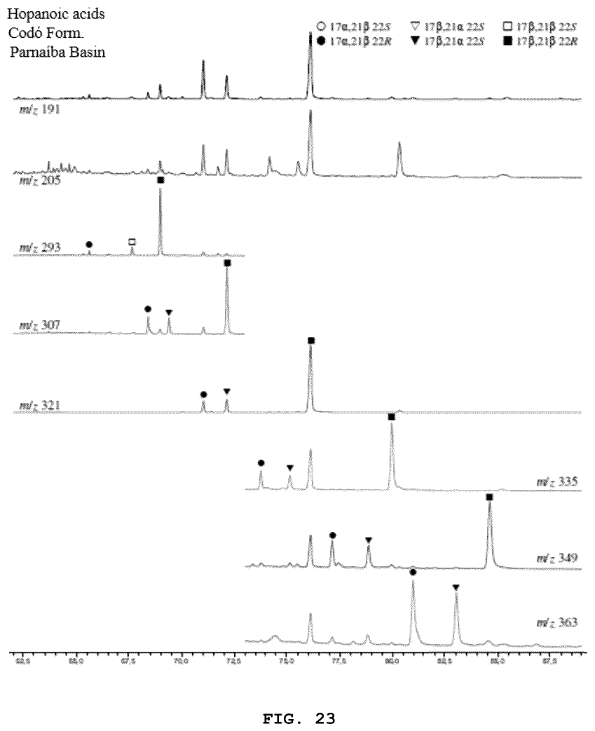

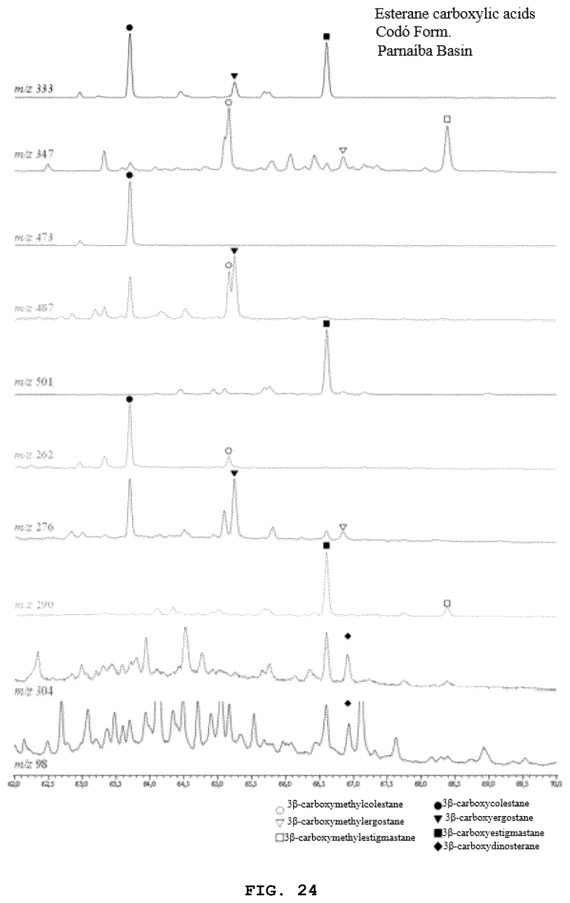

Application of the SiO₂/Ca(OH)₂ phase in different matrices: FIGS. 22, 23 and 24 show chromatograms of the distribution of carboxylic acids in the acidic fraction of a rock from the Codó Formation, Parnaiba Basin, extracted with Ca(OH)₂-modified silica. In both oil samples and sedimentary rock extracts, the applied method managed to recover satisfactory concentrations of acid biomarkers for their identification. Given the lower complexity in the chemical composition expected for the organic matter present in sedimentary rocks relative to that normally found in oils, the relative concentration of these compounds evidenced in the sedimentary rock extracts subjected to the method proposed herein was even greater. FIGS. 2 and 4 demonstrate the effectiveness of the methodology in different matrices. The identified components are listed in Tables 3 (copaiba) and 4 (Protium heptaphylum), with the analysis being made similarly to that of oil and sedimentary rock extracts.

Based on the teachings of the present invention and its potential impact on the oil sector, the expected advantages are multiple and significant:

### Economic Advantages/Yield

The SPE method using SiO₂/Ca(OH)₂ has been shown to be highly effective, particularly in terms of processing time, ease of operation, excellent cost-effectiveness, and high extraction efficiency (exceeding 75%). The use of silica modified with calcium hydroxide (Ca(OH)₂) instead of commercial phases (SAX type) not only simplifies the process of preparing the stationary phase, but can also result in lower operational costs due to the relatively lower availability and cost of the reagents involved. In summary, the SPE methodology using SiO₂/Ca(OH)₂ is robust and easy to execute, requiring fewer steps and resources compared to additional extraction techniques.

### Health/Safety

Application of the extraction process on a smaller scale provided by the developed method results in lower amounts of chemical products, which ensures better control of contingency processes and less generation of toxic vapors and residues.

### Reliability

The method offers an improved yield in the extraction of acidic biomarkers, providing a better qualitative and quantitative analysis of the target components in the samples, which is essential in several scientific and industrial applications.

### Environmental Advantages

The proposed method uses fewer organic solvents compared to conventional approaches, contributing to a reduced environmental impact and promoting more sustainable practices in the analysis of organic compounds. Furthermore, the extraction process efficiency on a smaller scale results in lower energy consumption, which is beneficial from both an economic and environmental perspective.

### REFERENCES

[1] Lopes J A D. Estudo de Biomarcadores em Óleos do campo Fazenda Belém, Bacia Potiguar: Identificação de 3-alquil-e 3-carboxialquil Esteranos, constituinte de uma cova classe de Biomarcadores. Doutorate, Institute of Chemistry. 1995. 223. Thesis (Doctorate in Chemistry)—State University of Campinas, Campinas, São Paulo; 1995.
[2] Jaffe R, Albrecht P, Oudin J L. Carboxylic acids as indicators of oil migration: II. Case of the Mahakam Delta, Indonesia. Geochim Cosmochim Acta. 1988; 52(11):2599-607.
[3] Vaz De Campos M C, Oliveira E C, Filho P J S, Piatnicki C M S, Caramão E B. Analysis of tert-butyldimethylsilyl derivatives in heavy gas oil from brazilian naphthenic acids by gas chromatography coupled to mass spectrometry with electron impact ionization. J Chromatogr A. 2006; 1105(1-2 SPEC. ISS.):95-105.
[4] Vaz de Campos M C. Estudo dos ácidos Naftênicos do gasóleo pesado derivado do petróleo Marlim. Institute of Chemistry. 2005; Doctorate: 158.
[5] Seifert W K, Teeter R M. Preparative Thin-Layer Chromatography and High Resolution Mass Spectrometry of Crude Oil Carboxylic Acids. Anal Chem. 1969; 41(6):786-95.
[6] Seifert W K, Teeter R M. Identification of Polycyclic Aromatic and Heterocyclic Crude Oil Carboxylic Acids. Anal Chem. 1970; 42(7):750-8.
[7] Seifert W K, Howells W G. Interfacially Active Acids in a California Crude Oil. Isolation of Carboxylic Acids and Phenols. Anal Chem. 1969; 41(4):554-62.
[8] Seifert W K, Gallegos E J, Teeter R M. Proof of Structure of Steroid Carboxylic Acids in a California Petroleum by Deuterium Labeling, Synthesis, and Mass Spectrometry. J Am Chem Soc. 1972; 94(16):5880-7.
[9] Borgund A E, Erstad K, Barth T. Normal phase high performance liquid chromatography for fractionation of organic acid mixtures extracted from crude oils. J Chromatogr A. 2007; 1149(2):189-96.
[10] Borgund A E, Erstad K, Barth T. Fractionation of crude oil acids by HPLC and characterization of their properties and effects on gas hydrate surfaces. Energy and Fuels. 2007; 21(5):2816-26.
[11] Green J B. Liquid chromatography on silica using mobile phases containing tetraalkylammonium hydroxides. I. General separation selectivity and behavior of typical polar compounds in fuels. J Chromatogr A. 1986; 358(C):53-75.
[12] Green J B, Stierwalt B K, Thomson J S, Treese C A. Rapid Isolation of Carboxylic Acids from Petroleum Using High-Performance Liquid Chromatography. Anal Chem. 1985; 57(12):2207-11.
[13] Mccarthy R D, Duthie A H. A rapid quantitative method for the separation of free fatty acids from other lipids. J Lipid Res. 1962; 3(1):117-9.
[14] Keeney M. A Survey of United States Butterfat Constants. II. Butyric Acid. Journal of Association of Official Agricultural Chemists. 1956; 39(1):212-25.
[15] Jaffe R, Albrecht P, Oudin J L. Carboxylic acids as indicators of oil migration-I. Occurrence and geochemical significance of C-22 diastereoisomers of the (17 pH, 21 pH) C30 hopanoic acid in geological samples. Advances in Organic Geochemistry. 1988; 13(1-3):483-8.
[16] Jaffe R, Gallardo M T. Application of carboxylic acid biomarkers as indicators of biodegradation and migration of crude oils from the Maracaibo Basin, Western Venezuela. Org Geochem. 1993; 20(7):973-84.
[17] Farrimond P, Griffiths T, Evdokiadis E. Hopanoic acids in Mesozoic sedimentary rocks: Their origin and relationship with hopanes. Org Geochem. 2002; 33(8):965-77.
[18] Barakat A O, Rullkotter J. Extractable and bound fatty acids in core sediments from the Nordlinger Ries, southern Germany. Fuel. 1995; 74(3):416-25.
[19] Jones D M, Watson J S, Meredith W, Chen M, Bennett B. Determination of naphthenic acids in crude oils using nonaqueous ion exchange solid-phase. Anal Chem. 2001; 73(3):703-7.
[20] Jones D, West C E, Scarlett A G, Frank R A, Rowland S J. Isolation and estimation of the “aromatic” naphthenic acid content of an oil sands process-affected water extract. J Chromatogr A. 2012; 1247:171-5.
[21] Lamorde U A, Parnell J, Bowden S A. Constraining the genetic relationships of 25-norhopanes, hopanoic and 25-norhopanoic acids in onshore Niger Delta oils using a temperature-dependent material balance. Org Geochem. 2015; 79:31-43.
[22] Sessions A L, Jahnke L L, Schimmelmann A, Hayes J M. Hydrogen isotope fractionation in lipids of the methaneoxidizing bacterium Methylococcus capsulatus. Geochim Cosmochim Acta. 2002; 66(22):3955-69.
[23] Zhu G T, He S, He X M, Zhu S K, Feng Y Q. A micro-solid phase extraction in glass pipette packed with aminofunctionalized silica for rapid analysis of petroleum acids in crude oils. RSC Adv. 2017; 7(64):40608-14.
[24] Alek André Costa de Sousa, Edymilaís da Silva Sousa, Gustavo Rodrigues de Sousa Junior, Carlos Alberto Carbonezi, Andre Luiz Durante Spigolon, Ailton Silva Brito, Sidney Gonçalo de Lima, An alternative method for the separation and analysis of acidic biomarkers from crude oil samples, Journal of South American Earth Sciences, Volume 120, 2022, 104054, ISSN 08959811.
[25] Wei Ni, Gangtian Zhu, Fei Liu, Zhiyong Li, Can Xie, and Yuanjia Han, Carboxylic Acids in Petroleum: Separation, Analysis, and Geochemical Significance, Energy & Fuels, 2021, No. 16, pages 12828-12844, DOI: 10.1021/acs.energyfuels.1c01518.

1. A method for extracting acidic biomarkers from oil samples in extracts of sedimentary rocks and plant material, the method comprising:
(1) modifying silica with Ca(OH)₂ at a concentration between 2 and 10% by weight;
(2) assembling a solid-phase extraction (SPE) cartridge and packing it with the modified SiO₂/Ca(OH)₂ stationary phase;
(3) preparing and applying a sample followed by elution; and
(4) derivatizing with N,O-bis(trimethylsilyl)trifluoroacetamide (BSTFA) for analysis by gas chromatography-mass spectrometry.

2. The extraction method of claim 1, wherein the modification of silica with Ca(OH)₂ is carried out by dissolving Ca(OH)₂ in isopropanol, wherein the silica is gradually added to a resulting isopropanol-Ca(OH)₂ suspension.

3. The method of claim 1, wherein solvent used for packing the modified SiO₂/Ca(OH)₂ stationary phase comprises diethyl ether.

4. The extraction method of claim 1, wherein the sample preparation in step (3) comprises spiking the sample with 5.0 pg of ibuprofen and 2.5 pg of homopregnanic acid prior to application in the solid phase extraction (SPE) cartridge.

5. The extraction method of claim 1, wherein solvents used for elution of the sample in step (3) comprise ethyl ether and formic acid.

6. A method comprising use of a modified SiO₂/Ca(OH)₂ stationary phase in isolation of acidic biomarker-enriched fractions.

7. The metho of claim 6, wherein the isolation of acidic biomarkers is carried out in oil samples, in extracts of sedimentary rocks and plant material.
